(19) United States
(12) Patent Application Publication
(10) Pub. No.: US 2008/0141552 A1
(43) Pub. Date: Jun. 19, 2008

(54) Steam dryer

(75) Inventors: Sang Hun Bae, Changwon-si (KR); Chang Woo Son, Changwon-si (KR); Chul Jin Choi, Changwon-si (KR); Dong Hyun Kim, Changwon-si (KR); Young Bok Son, Changwon-si (KR); Heung Jae Kim, Changwon-si (KR)

Correspondence Address: MCKENNA LONG & ALDRIDGE LLP, 1900 K STREET, NW, WASHINGTON, DC, 20006, US

(73) Assignee: LG ELECTRONICS INC., Seoul (KR)

(21) Appl. No.: 11/980,752

(22) Filed: Oct. 31, 2007

(30) Foreign Application Priority Data
Dec. 18, 2006 (KR) 10-2006-0129322
Dec. 18, 2006 (KR) 10-2006-0129323

(51) Int. Cl. F26B 19/00

(52) U.S. Cl. 34/108

(57) ABSTRACT

A steam dryer is disclosed, by which creases left on clothes and the like can be prevented or removed, by which water can be easily and conveniently supplied to a cartridge to facilitate the cartridge to be cleaned, and by which water can be easily and conveniently supplied to a cartridge to facilitate a filter of the cartridge to be replaced. The present invention includes a drum to be selectively rotatable, a hot-air heater to heat air to supply hot air to the drum, a steam generator to supply stem to the drum, and a water container to store water to be supplied to the steam generator, the water container having a supply hole on a upper portion.

This application claims the benefit of the Korean Patent Application No. 10-2006-0129322 and 10-2006-0129323, filed on Dec. 18, 2006, which is hereby incorporated by reference as if fully set forth herein.

### BACKGROUND OF THE INVENTION

1. Field of the Invention

The present invention relates to a dryer, and more particularly, to a steam dryer. Although the present invention is suitable for a wide scope of applications, it is particularly suitable for removing or preventing wrinkles or creases of clothes and the like.

2. Discussion of the Related Art

Generally, a dryer is a home appliance for drying washed clothes or laundry using hot air. And, the dryer normally consists of a drum for accommodating a laundry or object to be dried therein, a driving source for driving the drum, a heating means for heating air introduced into the drum, and a blower unit for sucking or discharging air within the drum.

Dryers are categorized into an electrical dryer and a gas type dryer according to an air heating system, i.e., the heating means. The electrical dryer generates hot air using heat of electric resistance, whereas the gas type dryer generates heat using gas combustion.

Alternatively, dryers can be categorized into a condensing type dryer and an exhaust type dryer. In the condensing type dryer, humid air attributed to heat exchange with an object to be dried in a drum circulates within the dryer instead of being externally discharged. The humid air exchanges heat with external air in a separately provided condenser to turn into condensed water and is then discharged to an external environment. In the exhaust type dryer, humid air attributed to heat exchange with an object to be dried is directly discharged to an external environment.

Alternatively, dryers can be categorized into a top-loading type dryer and a front-loading type dryer according to a type for inputting an object to a dryer. In the top-loading type dryer, an object to be dried is inputted via a topside of the dryer. In the front-loading type dryer, an object to be dried is inputted via a front side of the dryer.

However, the related art dryers have the following problems or disadvantages.

First of all, after completion of washing and dewatering, a laundry is normally inputted to the related art dryer and then dried. Yet, the water-washed laundry normally has wrinkles or creases thereon. And, it is difficult to remove the wrinkles or creases from the laundry in the drying course. So, the object or laundry having been fully dried in the related art dryer needs to be additionally pressed to remove the wrinkles or creases remaining on the object or laundry.

Secondly, since clothes and the like are normally kept in a closet or drawer, wrinkles, creases and the like (hereinafter generically named ‘creases’) are left on the clothes and the like. So, the demand for developing a tool for removing the creases from the normally used or kept clothes and the like conveniently has risen.

### SUMMARY OF THE INVENTION

Accordingly, the present invention is directed to a steam dryer that substantially obviates one or more problems due to limitations and disadvantages of the related art.

An object of the present invention is to provide a steam dryer, by which creases left on clothes and the like can be prevented or removed.

Another object of the present invention is to provide a steam dryer, by which water can be easily and conveniently supplied to a cartridge to facilitate the cartridge to be cleaned.

A further object of the present invention is to provide a steam dryer, by which water can be easily and conveniently supplied to a cartridge to facilitate a filter of the cartridge to be replaced.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a steam dryer according to the present invention includes a drum to be selectively rotatable, a hot-air heater to heat air to supply hot air to the drum, a steam generator to supply steam to the drum, and a water container to store water to be supplied to the steam generator, the water container having a supply hole on a upper portion.

Preferably, the water container includes a lower housing to store the water and an upper housing detachably assembled to the lower housing, wherein the supply hole is provided to one side of the upper housing.

More preferably, the water container is detachable.

More preferably, the lower housing has an entirely open side and the upper housing is configured to cover the open side of the lower housing.

More preferably, the steam dryer further includes a sealing member provided between the upper housing and the lower housing to prevent leakage of the water stored in the lower housing.

In this case, the sealing member is provided to at least one of the upper housing and the lower housing. A groove is provided to an edge of the upper housing to be downwardly open and the sealing member is inserted in the groove to be built in one body of the upper housing.

More preferably, the water container further includes an extension portion extending from one side of the upper housing to have a hole and a holding portion projected from one side of the lower housing to correspond to the hole.

In this case, a holding sill is provided to a tip of the holding portion and the upper housing is assembled to the lower housing in a manner that the holding sill is forcibly fitted into the hole.

More preferably, the steam dryer further includes a cover to open and close the supply hole.

In this case, the cover is hinged to the upper housing. In other words, the cover is assembled to the upper housing in a manner that one side of the cover is fixed to the upper housing and that the other side of the cover is detachably assembled to the upper housing. And, the steam dryer further includes a hinge part enabling the cover to be rotatably assembled to the upper housing.

In particular, the steam dryer further includes an elastic member generating a predetermined elastic force in a direction of opening the cover. And, the cover and the upper housing are so configured that the cover is maintained at a predetermined angle when opened.

And, an extension portion projected from a backside of the cover to enable the cover to be forcibly fitted into the supply hole. Moreover, at least one holding sill outwardly projected from the extension portion is further provided to the cover.

In this case, a seating recess is provided to a topside of the upper housing to enable the cover to be seated thereon and a fingering recess is provided to one side of the seating recess. And, an opening recess is provided to a portion of the cover in the vicinity of the fingering recess when the cover is seated on the seating recess.

Preferably, the supply hole is arranged relatively lower than the topside of the water container.

More preferably, the topside of the water container has a predetermined angle of inclination.

In this case, the predetermined angle of the inclination of the topside of the water container is gradually reduced toward a center of the topside from a circumference of the topside.

More preferably, a cover is provided to the supply hole and a topside of the cover is arranged higher than the topside of the water container.

In this case, the cover is detachably provided. And, a filter is provided between the topside of the cover and the topside of the water container. Moreover, the filter is detachably provided.

More preferably, a filter is provided to the supply hole.

Accordingly, the present invention effectively prevents and/or removes the creases from the clothes and the like.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is an exploded perspective diagram of a steam dryer according to one embodiment of the present invention;

FIG. 2 is a cross-sectional diagram of the steam dryer shown in FIG. 1;

FIG. 3 is a cross-sectional diagram of a steam generator shown in FIG. 1;

FIG. 4 is a diagram of an example of a steam dryer according to another embodiment of the present invention, in which a configuration of a steam generator is mainly shown;

FIG. 5 is an exploded perspective diagram of a water container shown in FIG. 4;

FIG. 6 is an exploded perspective diagram of a water softening member shown in FIG. 5;

FIG. 7 is an exploded perspective diagram of another example of the water container shown in FIG. 4;

FIG. 8 is a perspective diagram of an assembly of the water container shown in FIG. 7;

FIG. 9 is a cross-sectional diagram according to a cutting line I-I′ shown in FIG. 8;

FIG. 10 and FIG. 11 are diagrams of an example of a hinge part of the water container shown in FIG. 7;

FIG. 12 is a diagram of another example of a hinge part of the water container shown in FIG. 7;

FIG. 13 is an exploded perspective diagram of a further example of the water container shown in FIG. 4; and

FIG. 14 is a cross-sectional diagram according to a cutting line II-II′ shown in FIG. 13.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

First of all, in the following description of a steam dryer according to the present invention, a top-loading electric condensing type steam dryer is explained as an embodiment of the present invention for convenience of explanation. And, it is a matter of course that the present invention is applicable to a front-loading gas condensing type steam dryer and the like.

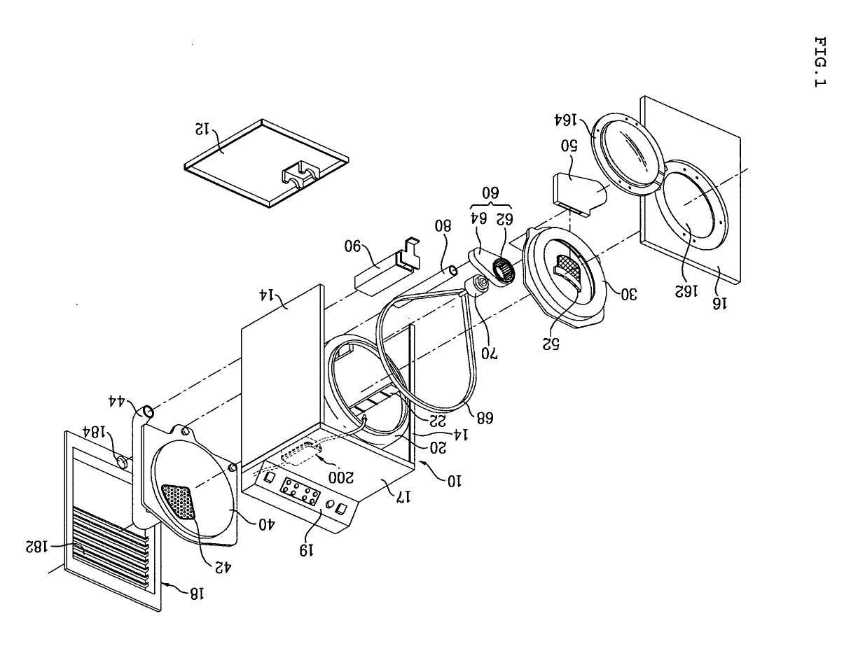

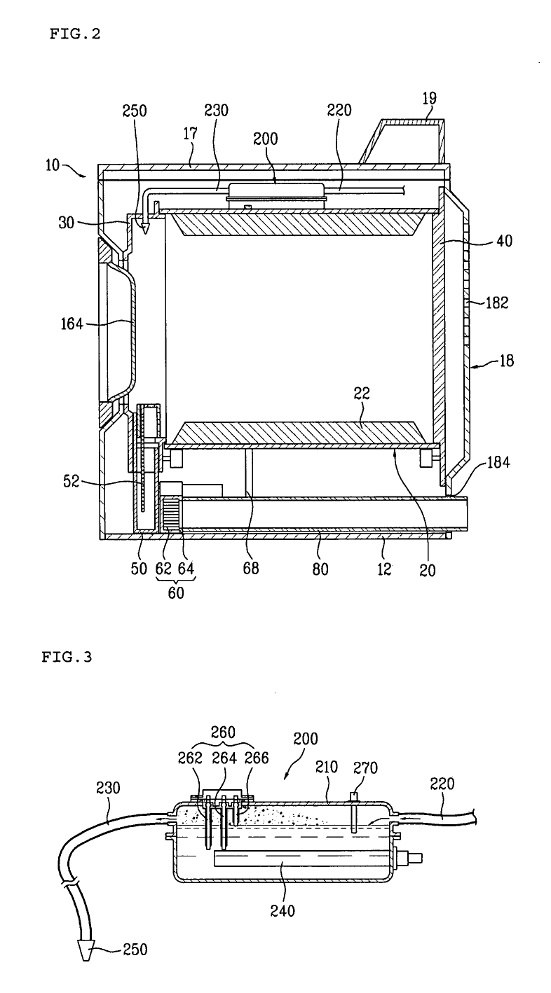

A steam dryer according to one embodiment of the present invention is explained with reference to FIG. 1 and FIG. 2 as follows.

FIG. 1 is an exploded perspective diagram of a steam dryer according to one embodiment of the present invention and FIG. 2 is a cross-sectional diagram of the steam dryer shown in FIG. 1.

Referring to FIG. 1 and FIG. 2, a rotatable drum 20 and a motor and belt 70 and 80 for rotating the drum 20 are provided within a cabinet 10 configuring an exterior of a steam dryer.

A heater 90 for heating air to generate hot air (hereinafter called ‘hot air heater’) and a hot air supplying duct 44 for supplying the hot air generated by the hot air heater 90 to the drum 20 are provided to predetermined parts of the cabinet 10. And, an exhaust duct 80 for discharging humid air after completion of heat exchange with an object to be dried within the drum 20 and a blower unit 60 for sucking in the humid air are further provided within the cabinet 10.

Meanwhile, a steam generator 200 for generating high-temperature steam is provided to a specific part of the cabinet 10. The present embodiment employs an indirect drive type system for rotating the drum 20 using the motor 70 and the belt 68, which does not restrict the scope of the present invention. Alternatively, it is a matter of course that the present invention is applicable to a direct drive type system.

The respective elements of the present invention are explained in detail as follows.

First of all, the cabinet 10 configures the exterior of the steam dryer. The cabinet 10 includes a base 12 forming a bottom side, a pair of side covers 14 vertically provided to the base 12, a front cover 16 assembled to a pair of the side covers 14 to configure a front side of the cabinet 10, a rear cover 18 assembled to a pair of the side covers 14 to configure a rear side of the cabinet 10, and a top cover 17 assembled to a pair of the side covers 14 to configure a topside of the cabinet 10.

A control panel 19 having various operation switches and the like is provided to the top cover 17 or the front cover 16. A door 164 is provided to the front cover 16. And, the rear cover 18 is provided with an intake part 182 for introducing external air into the cabinet and an exhaust hole 184 playing a role as a final passage in discharging air from the drum 20 externally.

An inner space of the drum 20 plays a role as a drying chamber for processing a drying course therein. Preferably, at least one lift 22 is provided within the drum 20 to turn over an object to be dried in a manner of lifting up the object to fall. So, drying efficiency can be raised.

A front support 30 is provided between the drum 20 and the front cover 16 of the cabinet 10. And, a rear support 40 is provided between the drum 20 and the rear cover 18 of the cabinet 10. So, the drum 20 is rotatably provided between the front and rear supports 30 and 40. Preferably, a sealing member (not shown in the drawing) is provided between the drum 20 and each of the front and rear supports 30 and 40 to prevent leakage. In particular, the front and rear supports 30 and 40 block front and rear sides of the drum 20 to configure a drying chamber and play a role in supporting front and rear end portions of the drum 20, respectively.

An opening is provided to the front support 30 to enable the drum 20 to externally communicate with an external environment of the steam dryer. And, the opening is selectively closed by the door 164.

A lint duct 50, which plays a role as a passage for discharging the air from the drum 20 externally, is connected to the front support 30 and a lint filter 52 is provided to the lint duct 50.

One end of the blower unit 60 is connected to the lint duct 50 and the other end of the blower unit 60 is connected to the exhaust duct 80. And, the rear duct 80 is configured to communicate with the exhaust hole 184 provided to the rear cover 80.

So, once the blower unit 60 is activated, the air within the drum 20 is externally discharged via the lint duct 50, the exhaust duct 80, and the exhaust hole 184 in series. In doing so, particles including lint and the like are filtered off by the lint filter 52.

The blower unit 60 generally includes a blower 62 and a blower housing 64. In particular, the blower 64 is normally driven by being connected to the motor 70 for rotating the drum 20.

An opening 42 including a multitude of perforated holes is provided to the rear support 40. And, a hot air supplying duct 44 is connected to the opening 42. The hot air supplying duct 44 communicates with the drum 20 to play a role as a passage for supplying hot air to the drum 20. So, a hot air heater 90 is provided to a predetermined part of the hot air supplying duct 44.

Meanwhile, the steam generator 200 is provided to a predetermined part of the cabinet 10 to generate and supply steam to the drum 20. The steam generator 200 is explained in detail with reference to FIG. 3 as follows.

First of all, the steam generator 200 includes a tank 200 for accommodating water therein, a heater 240 provided within the water tank 210, a water level sensor 260 for measuring a water level within the steam generator 200, and a temperature sensor 270 for measuring a temperature within the steam generator 200.

In particular, the water level sensor 260 normally includes a common electrode 262, a low water level electrode 264, and a high water level electrode 266. And, the water level sensor 260 detects a high/low water level in correspondence to a presence or non-presence of a short circuit between the common electrode 262 and the high/low water level electrode 266/264.

A water supply hose 220 for supplying water is connected to one side of the steam generator 200 and a steam hose 230 for discharging steam is connected to the other side of the steam generator 200. Preferably, a nozzle having a predetermined shape is provided to a front end portion of the stem hose 230. Generally, one end portion of the water supply hose 220 is connected to an external water container such as a tap and the front end portion of the steam hose 230 or the nozzle 25, i.e., a steam outlet is provided to a predetermined part of the drum 20 to inject the steam into the drum 20.

Meanwhile, the present embodiment employs and describes the steam generator 200 (hereinafter named ‘tank heating type steam generator’) generating the steam by enabling the heater 240 to heat a predetermined quantity of the water accommodated in the water tank 210 having a prescribe size, which does not restrict the scope or implementations of the present invention. So, any device capable of generating steam is applicable to the present invention to be used as a steam generator. For instance, a heater is directly provided to a circumference of a water supply hose for carrying water therein and the water is heated (hereinafter named ‘pipe heating type’).

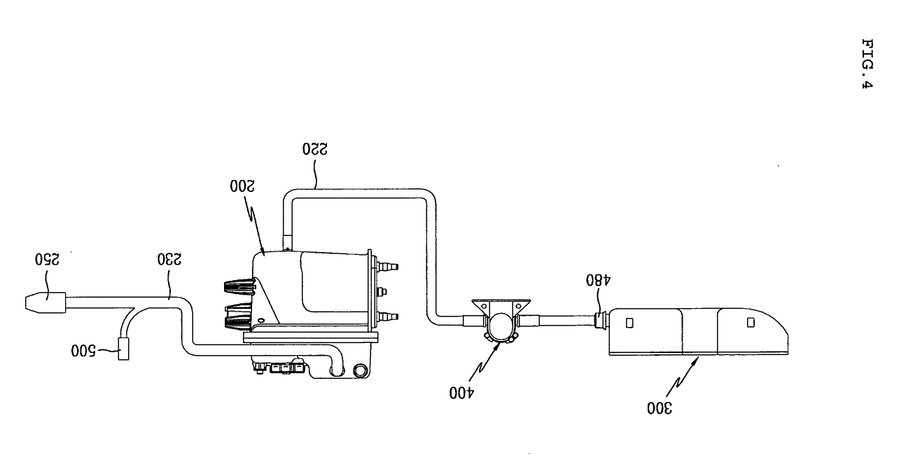

A steam dryer according to another embodiment of the present invention is explained with reference to FIG. 4 as follows.

FIG. 4 is a diagram of an example of a steam dryer according to another embodiment of the present invention, in which a configuration of a steam generator is mainly shown.

Referring to FIG. 1, a water container for supplying water to a steam generator 200 is detachably provided. In the former embodiment of the present invention, the water container is the tap that needs a complicated installation work. Since a steam dryer normally does not use water, if a tap is to be used as a water container, various devices should be provided in addition. Hence, the present embodiment employs a detachable water container 300. The water container 300 is detached from the steam generator 200 to be filled with water. The water container 300 filled with the water is then conveniently connected to a water supplying passage, i.e., a water supply hose 220 of the steam generator 200.

Preferably, a pump 400 is provided between the water container 300 and the steam generator 200. In particular, a drain portion of the water container 300 is fitted into a connecting mouth 480, whereby the pump 400 is connected to the water container 300 to communicate with. And, the pump 400 is connected to the steam generator 200 via the water supply hose 220.

More preferably, the pump 400 enables its forward and reverse rotations to supply water to the steam generator 200 or recollect the water remaining in the steam generator 200 if necessary.

Alternatively, it is able to supply water to the steam generator 200 using a water column difference between the water container 300 and the steam generator 200. Yet, since various parts of the steam generator are standardized and designed compact to result in spatial shortage. So, the water supply using the water column difference is substantially impossible unless sizes of the various parts of the conventional dryer are modified. So, a small-size pump 400 is very usefully used to install the steam generator 200 without modifying the sizes of the various parts of the conventional dryer. Besides, the remaining water of the steam generator 200 is recollected to prevent the heater from being damaged if the steam generator 200 is not used long for a considerable time. And, the remaining water may turn into foul water to be used later.

In the former embodiment of the present invention, the water supply and the steam discharge take place in the upper part of the steam generator 200. Preferably, in the present embodiment, water is supplied to a lower part of the steam generator 200 and steam is discharged from an upper part of the steam generator 200. This configuration has the advantage in collecting the remaining water from the steam generator 200.

Preferably, a safety valve 500 is provided to a steam passage for discharging steam from the steam generator 200, and more particularly, to the steam hose 230.

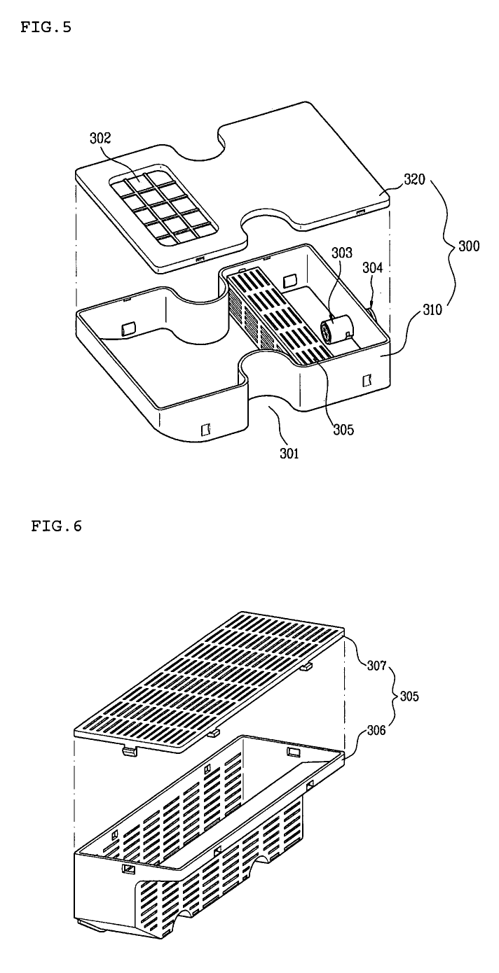

FIG. 5 is an exploded perspective diagram of a water container shown in FIG. 4. In the following description, a detachable water container (hereinafter named ‘cartridge’ for convenience) 300 is explained in detail with reference to FIG. 5.

Referring to FIG. 5, a cartridge 300 includes a lower housing 310 substantially accommodating water therein and an upper housing 320 detachably assembled to the lower housing 310. Thus, if the cartridge 300 includes the lower and upper housings 310 and 320, it facilitates the cartridge 300 to be cleaned in cleaning fur and the like from the cartridge 300. And, filters 302 and 303 and a water softening member 305 are easily detached to facilitate cleaning or reproduction.

Preferably, a first filter 302 is provided to the upper housing 320. In particular, the first filter 302 is provided to a water introducing portion of the upper housing 320 to primarily filter water supplied to the cartridge 300.

Preferably, a switching member 304 for draining water from the cartridge 300 selectively is provided to the lower housing 310. If the cartridge 300 is detached, the water avoids draining from the cartridge 300. If the cartridge 300 is attached, water drains away from the cartridge 300.

Preferably, a second filter 303 for filtering water is connected to the switching member 304. More preferably, the second filter 303 is detachably provided to the switching member 304.

Thus, using the first and second filters 302 and 303, it is able to doubly filter off impurities including micro-dust and the like from water. Preferably, the first and second filters 302 and 303 are configured to have about 50- and 60-mesh nets, respectively. In this case, the 50-mesh net means that the number of meshes per a predetermined size is 50. Since each hole configuring the meshes of the first filter 302 is larger than that of the second filter 303, the first filter 302 primarily filters off relatively large particles and the second filter 303 secondarily filters off relatively small particles.

Preferably, the water softening member 305 is further provided within the cartridge 300 to soften water therein. More preferably, the water softening member 305 is detachably provided with the cartridge 300.

The water softening member 305, as shown in FIG. 6, includes a lower housing having a multitude of perforated holes and an upper housing 307 having a multitude of perforated holes to be detachably attached to the lower housing.

Preferably, an ion-exchange resin (not shown in the drawing) is included in a space defined by the upper and lower housings 307 and 306.

The water softening member 305 is used for the following reason.

First of all, if hardness of water supplied to the steam generator 200 is high, Ca(HCO₃)₂ dissolved in water is heated to extract CaCO₃ that causes corrosion to the heater and the like. Water in Europe or America tends to have high hardness, which may accelerate the corrosions. By eliminating calcium ions, magnesium ions and the like using the ion-exchange resin, precipitation of lime is preferably prevented in advance.

Besides, as performance of the ion-exchange resin is reduced in progress of water softening, the ion-exchange resin is preferably reproduced using NaCl. For reference, a water softening process by the ion-exchange resin follows 2(R—SONa)+Ca2<->(R—SO)Ca+2Na, and a reproduction process follows (R—SO)Ca+2NaCl<->2(R—SONa)+CaCl.

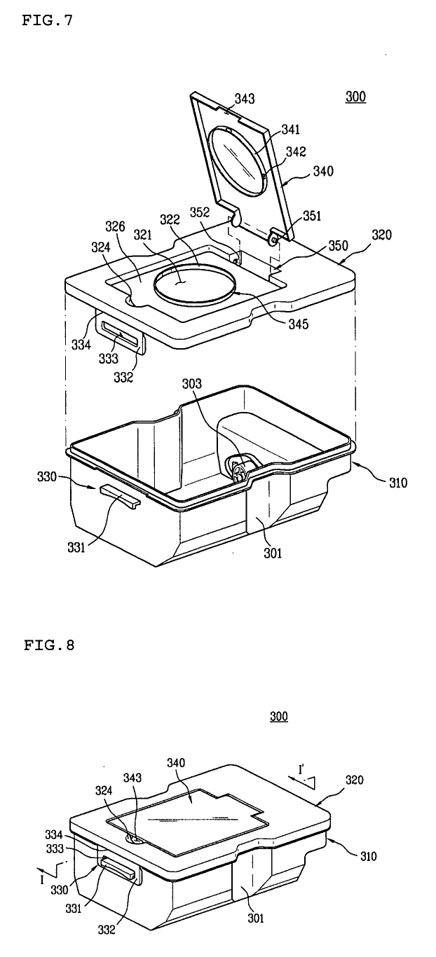

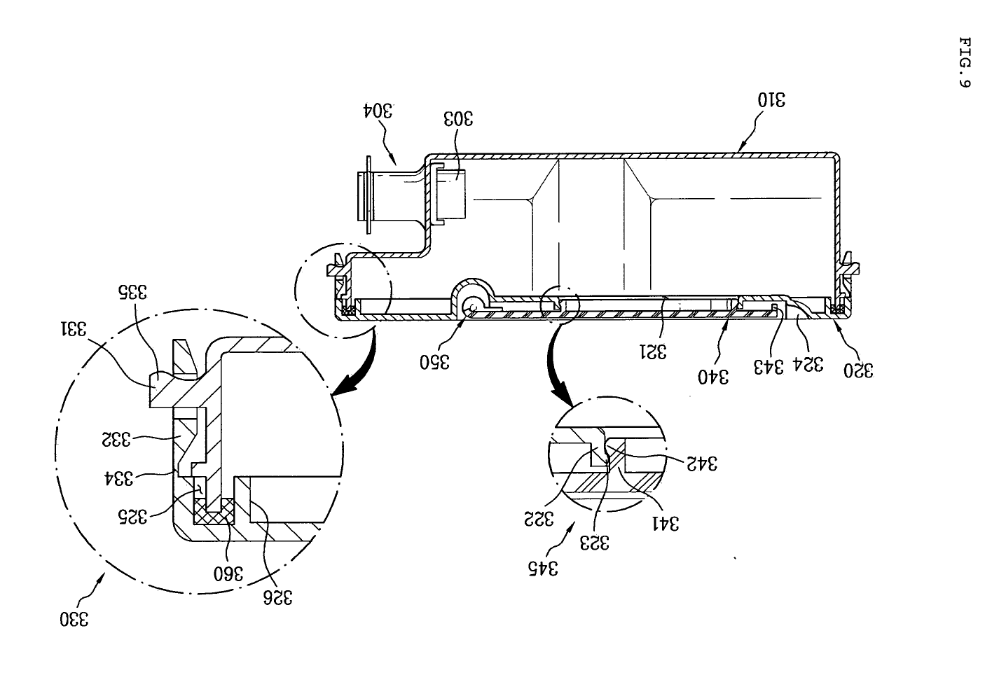

FIG. 7 is an exploded perspective diagram of another example of the water container shown in FIG. 4, FIG. 8 is a perspective diagram of an assembly of the water container shown in FIG. 7, and FIG. 9 is a cross-sectional diagram according to a cutting line I-I′ shown in FIG. 8.

Referring to FIGS. 7 to 9, compared to the cartridge of the former embodiment of the present invention, a cartridge 300 according to another embodiment of the present invention further includes a cover 340 for opening/closing a supply hole 321 for supplying water and a locking part 330 facilitating the upper housing 320 to be detachably attached to the lower housing 310.

According to the cartridge 300 of the present embodiment, a user opens the cover 340 to supply water through the supply hole 321 with ease. And, the cover 340 is able to prevent particles from being introduced into the supply hole 321.

Generally, a user supplies water to the cartridge 300 and often cleans the cartridge 300. In case of attempting to supply water, the user just opens the cover 340. In case of attempting to clean the inside of the cartridge 300, a user conveniently detaches the upper housing 320 from the lower housing 320.

Preferably, the cartridge 300 of the present embodiment is detachably provided to a steam dryer. Alternatively, the lower housing 310 can be detachably provided to the steam dryer or fixed to the steam dryer. Even if the lower housing 310 is fixed to the stem dryer, a user is facilitated to supply water via the supply hole 321 and clean the inside of the lower housing 310 by separating the upper housing 320 from the lower housing 310.

The cartridge 300 according to another embodiment of the present invention is explained in detail as follows. Compared to the elements of the former embodiment shown in FIG. 5, different elements are explained in detail. And, the description and drawing of FIG. 5 are applied to the same elements.

First of all, the locking part 330 facilitating the upper housing 320 to be detachably attached to the lower housing 310 is explained.

Preferably, the locking part 330 is configured detachable to fully open one whole side of the lower housing 310 if the upper housing 320 is detached from the lower housing 310. If so, a user is further facilitated to clean the inside of the cartridge 300.

The locking part 330 can include an extension portion 332 extending from one side of the upper housing 320 to have a hole 333 at its central part and a holding portion 331 projected from one side of the lower housing 310 to oppose the hole 333.

The extension portion can be configured to be rotated at a predetermined angle by the connecting part 34 of the upper housing 320. Since the extension portion 332 is configured to be rotated at a predetermined angle to make the hole 333 oppose the holding portion 331 only, the connecting part 334 can be configured to have a hinge structure. If so, the upper housing 320 can be easily attached to the lower housing 320 in a manner that the holding portion 331 is correspondingly held by the hole 333 due to the predetermined rotation of the extension portion 332 rotated at a predetermined angle by a user.

Preferably, the holding portion 331 and the hole 333 can be configured to be forcibly fitted into each other. If so, the upper housing 320 can be more firmly assembled to the lower housing 310.

More preferably, a holding sill 335 can be provided to a tip of the holding portion 331. If so, when the holding portion 331 opposes the hole 333, the holding sill 335 facilitates the holding portion 331 to be forcibly fitted into or separated from the hole 333. Hence, a user is facilitated to detachably assemble the upper housing 320 to the lower housing 310.

Preferably, the locking part 330 is configured to prevent leakage of the water accommodated in the lower housing 310 in case that the upper housing 320 is assembled to the lower housing 310. For this, the locking part 330 can further include a sealing member 360 provided to a contact area between the lower and upper housings 310 and 320 to prevent the water from leaking from the lower housing 310. In this case, the sealing member 360 can be installed at one of the upper and lower housings 320 and 310 at least. More preferably, the sealing member 360 can be formed of one of rubber, silicon, etc.

The locking part 330 can further include an extension portion 326 downwardly extending from an edge of the upper housing 320 to configure a groove 325 downwardly open. If so, the sealing member 360 is forced to be fitted into the groove 325 to be fixed thereto.

Preferably, the sealing member 360 is inserted in the groove 325 in case of molding the upper housing 320 to be built in one body of the upper housing 320. If so, it is able to prevent the sealing member 360 from being lost in case of attaching/detaching the upper housing 320.

Preferably, a recess, as shown in FIG. 9, is provided to the sealing member 360 to enable an upper end portion of the lower housing 310 to be fitted into the recess. If so, when the holding portion 331 is forced to be fitted into the hole 333, the end portion of the edge of the lower housing 310 packs the recess provided to the sealing member 360 to securely prevent the water from leaking from the lower housing 310.

More preferably, a cross-section of the sealing member 360 is configured to have a shape [symbol] . If so, the recess can be naturally formed in the sealing member 360. And, the sealing member 360 is facilitated to be inserted in the groove 325 having a cross-section of [symbol] as well to be formed in one body.

In the present embodiment, the hole 333 is provided to the extension portion 332 and the holding sill 335 is provided to the holding portion 331. Alternatively, the holding sill is provided to the tip of the extension portion 332 and the hole is provided to the holding portion 331.

Alternatively, a holding sill can be provided to the tip of the extension portion 332 to replace the hole 333. In this case, the holding sill 335 of the holding portion 331 is forced to be fitted into the holding sill provided to the tip of the extension portion 332, whereby the upper housing 320 can be securely assembled to the lower housing 310.

In the present embodiment, the groove 325 is provided to the edge of the upper housing 320 and the tip of the edge of the lower housing 310 is fitted into the groove. Alternatively, a groove is provided to the tip of the upper edge of the lower housing 310 and the end portion of the edge of the upper housing 320 can be fitted into the groove.

A structure for the cover 340 to open/close the supply hole 321 is explained in detail as follows.

First of all the cartridge 300 according to the present embodiment can include the supply hole 321 provided to the topside of the upper housing 320 to supply water and the cover 340 provided to open/close the supply hole 321.

The cartridge 300 may include the supply hole 321 only without the cover 340. Preferably, the cartridge 300 includes the cover 340 to prevent particles from being introduced through the supply hole 321.

The supply hole 321 is driven through one side of the upper housing 320 and has a size and shape suitable for supplying water. Preferably, the supply hole 321 is configured to have a circular shape to be supplied with water from a tap or the like. And, it is a matter of course that the first filter 302 (not shown in FIG. 7) can be provided to the supply hole 321 of the cartridge 300 according to the present embodiment.

The cover 340 can be assembled to the upper housing 320 to be completely separated from. Preferably, one side of the cover 340 is fixed to the upper housing 320 and the other side is detachably assembled to the upper housing 320. If so, the cover 340 can be prevented from being lost.

Preferably, in order for a user to open/close the supply hole 321, the cover 340 is assembled to the upper housing 320 to be rotatable at a predetermined angle or assembled to the upper housing 320 slidably. If so, the user is facilitated to open/close the supply hole 321 by rotating the cover 340 at a predetermined angle or sliding the cover 340.

More preferably, the cartridge 300 can further include a hinge part 350 to enable to cover 340 to be assembled to the upper housing 320 by being rotatable at a predetermined angle against the upper housing 320.

The hinge part 350 includes a pair of hinge shafts 351 outwardly projected from both sides of one side edge of the cover 340, respectively and a pair of hinge holes 352 provided to the upper housing 320 to enable a pair of the hinge shafts 351 to rotate by being fitted therein, respectively. If so, as a pair of the hinge shafts 351 are inserted in a pair of the hinge holes 352, respectively, the cover 340 is rotatably assembled to the upper housing 320.

Alternatively, a pair of the hinge shafts 351 can be provided to both sides of a portion partially extending from one side edge of the cover 340.

Meanwhile, it is preferable that the cartridge 300 further includes a fixing part 345 fixing the cover 340 thereto if the cover 340 fully coves the supply hole 321. If so, the cover 340 can be fixed thereto by closing the supply hole 321. Hence, it is able to prevent particles from being introduced via the supply hole 321 as well as prevent the water from leaking from the lower housing 310 via the supply hole 321 to some extent.

The fixing part 345 can include an insertion portion 341 projected and extending from a backside of the cover 340 to be forcibly fitted into the supply hole 321 if the cover 340 is closed. If so, the cover can be fixed to the supply hole 321 as the insertion portion 341 is forced to be fitted into the supply hole 321.

Preferably, the fixing part 345 further includes a plurality of holding sills 342 projected from an outer side of the insertion portion 341 to be spaced apart from each other and forcibly fitted into the supply hole 321. If so, a plurality of the holding sills 342 are forcibly fitted into the supply hole 321. Hence, the cover 340 can be securely fixed to the supply hole 321 by covering the supply hole 321.

Preferably, the fixing part 345 further includes a plurality of hooking sills 323, which are projected from a rim of the supply hole 321 to be spaced apart from each other, to engage with the holding sills 342 to achieve snap fitting. If a user pushes the holding sills 342 to be caught by the hooking sills 323, respectively, the cover can be more securely fixed to the supply hole 321 by covering the supply hole 321.

In this case, the hooking sills 323 can be directly provided to the rim of the supply hole 321. Alternatively, the hooking sills 323 can be projected from an inner side of the extension portion 322 upwardly or downwardly projected and extending from the rim of the supply hole 321.

Preferably, a seating recess 326 is provided to a topside of the upper housing 320 to have the cover 340 seated thereon in order for the closed cover 340 not to be projected.

More preferably, a depth of the seating recess 326 is set to enable the seated cover 340 to stay in the same plane of the topside of the upper housing 320. Hence, a user is provided with a fine view of a neat exterior.

Preferably, a fingering recess 324 is provided to one side of the seating recess 326 to facilitate a user to open the closed cover 340 seated on the seating recess 326.

More preferably, an opening recess 343 is provided to a lateral side of the cover 340 in the vicinity of the fingering recess 324. If so, even if the cover 340 is seated on the seating recess 326, a user is facilitated to open the cover 340, as shown in FIG. 8, in a manner of pulling up the cover 340 through the fingering recess 324 and the opening recess 343.

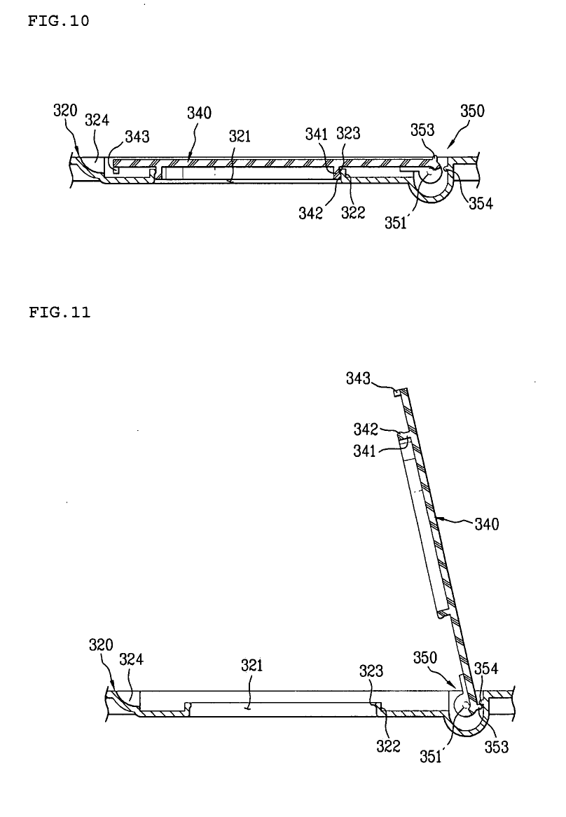

FIG. 10 and FIG. 11 are diagrams of an example of a hinge part of the water container shown in FIG. 7. FIG. 10 is a partial cross-sectional diagram of the cover in a closed status, and FIG. 11 is a partial cross-sectional diagram of the cover in an open and fixed status.

A hinge part 350 of the present embodiment just differs from the former hinge part of the former embodiment in further including a pair of projections 353 and 354. So, the same reference numbers will be used throughout the following description to refer to the same or like parts in-between.

Referring to FIG. 10 and FIG. 11, a hinge part 350 of the present embodiment further includes at least one projected portion 353 outwardly projected from one side of the cover 340 and at least one holding portion 354 projected from a portion of the upper housing 320 in the vicinity of the at least one projected portion 353 in a direction of the corresponding projected portion 353.

Preferably, each length of the projected and holding portions 353 and 354 is set to enable the projected portion 353 to go over the holding portion 354 by a predetermined force. If so, when the cover 340 is rotated to be opened or closed, the projected portion 353 is able to go over the holding portion 354 by a predetermined force. Once the projected portion 353 goes over the corresponding holding portion 354, it can maintained the status held by the holding portion 354 unless a force is applied in a reverse direction.

Preferably, the at least one projected portion 353 and the at least one holding portion 354 are provided to locations spaced apart from each other by a predetermined angle centering on the hinge shaft 351.

More preferably, the at least one holding portion 354 can be provided to the location spaced apart from the location of the at least one projected portion 353 by about 90 degrees clockwise. If so, while the cover 340 is closed, the at least one projected portion 353, as shown in FIG. 10, lies at the location spaced apart from the at least one holding portion 354 by about 90 degrees counterclockwise. In case that the cover 340 is opened at about 90 degrees, the at least one projected portion 353, as shown in FIG. 11, is rotated by about 90 degrees clockwise to go over the at least one holding portion 354. The at least one projected portion 353 is then held by the at least one holding portion 354.

In particular, if the cover 340 is open, it may be closed again by its weight. Since the at least one projected portion 353 is held by the holding portion 354, the cover 340 can be fixed thereto while opening the supply hole 321 entirely. In case of attempting to close the cover 340 again, a predetermined force is applied to enable the at least one projected portion 353 to go over the at least one holding portion 354 counterclockwise.

In case of attempting to supply water to the lower housing 310, a user opens the cover 340 and then applies a predetermined force to enable the at least one projected portion 353 to go over the at least one holding portion 354. If so, the cover 340 can be fixed to the status of opening the supply hole 321 entirely. Hence, water can be conveniently supplied via the supply hole 321.

By the hinge part 350 of the present embodiment, the cover 340 is opened by a predetermined angle at least and then fixed to the opened status. Hence, a user is further facilitated to supply water via the supply hole 321 without holding the cover 340 not to be closed.

Besides, the hinge part 350 of the present embodiment is just an embodiment for fixing the cover 340 opened by being rotated by a predetermined angle at least. Alternatively, many different embodiments for performing this function are applicable to the hinge part 350 to be covered by the present invention.

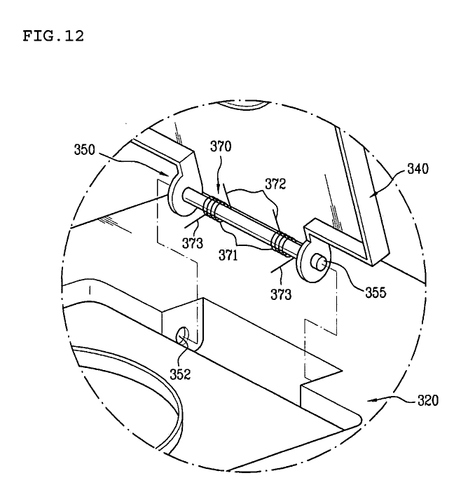

FIG. 12 is a diagram of another example of a hinge part of the water container shown in FIG. 7. A hinge part of the present embodiment differs from that of the former embodiment shown in FIG. 7 in further including a separate hinge shaft and an elastic member. So, the same reference numbers will be used throughout the following description to refer to the same or like parts in-between.

Referring to FIG. 12, a hinge part 350 of the present embodiment further includes a hinge shaft 355 passing through a hole (not shown in the drawing) of the cover 340 to be inserted in a pair of the hinge holes 352 and at least one elastic member 370 provided to the hinge shaft 355 to generate an elastic force in a direction of opening the cover 340.

The at least one elastic member 370 includes a body part 371 having the hinge shaft 35 fitted therein and a pair of end portions 372 and 373 respectively extending from both ends of the body part 371.

One 372 of a pair of the end portions 372 and 373 adheres closely to the cover 340 and the other 373 adheres closely to the upper housing 320. If so, the at least one elastic member 370 can generate the elastic force in a direction getting farther from the upper housing 320, i.e., in the direction of opening the cover 340.

In case of attempting to open the cover 340 to supply water, a user just pulls up the cover 340 via the fingering recess 342 and the opening recess 343 when the cover 340 is in a closed status, i.e., in a status that the holding sill 342 is held by the holding sill 323.

In particular, if the status that the holding sill 343 is held by the holding sill 323 is released by a user's force, the elastic force of the at least one elastic member 370 automatically opens the cover 340 in a status that the supply hole 321 is entirely open. Once the cover 340 is opened, it can maintain its open status due to the elastic force of the at least one elastic member 370.

After completion of the water supply, the cover 340 is closed in a manner that the holding sill 342 is caught by the hooking sill 323 again. In this case, the cover 340 can stay in the closed status despite the elastic force of the at least one elastic member 370.

According to the hinge part 350 of the present embodiment, the cover 340 is automatically and entirely opened and can sustain the entirely opened status, whereby user's convenience can be enhanced.

Besides, the hinge part 350 of the present embodiment is just an embodiment for opening the cover 340 automatically or fixing the cover 340 to the opened status. Alternatively, many different embodiments for performing this function are applicable to the hinge part 350 to be covered by the present invention.

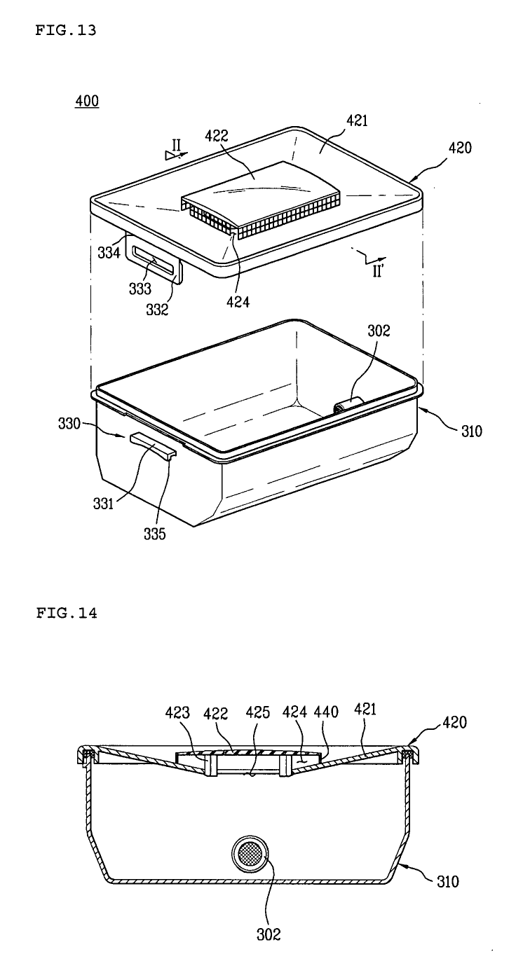

FIG. 13 is an exploded perspective diagram of a further example of the water container shown in FIG. 4, and FIG. 14 is a cross-sectional diagram according to a cutting line II-II′ shown in FIG. 13.

A cartridge 400 according to the present embodiment differs from that of the former embodiment in that a location of a water supply 421 for supplying water is different and that a cover 422 for covering the supply hole 421 is included. So, the same reference numbers will be used throughout the following description to refer to the same or like parts in-between. For instance, the above-mentioned description of the locking part 330 facilitating the upper housing 420 to be detachably attached to the lower housing 310 is cited.

Referring to FIG. 13 and FIG. 14, a water supply hole 425 for supplying water is provided to a topside of a cartridge 400, and more particularly, to a portion of the upper housing 420 relatively lower than a topside 421 of the upper housing 420. If a user pours water on the topside of the upper housing 420, the water is easily introduced into the supply hole 425 provided to the relatively lower portion of the topside of the upper housing 420.

The topside 421 of the upper housing 420 is configured to have a step shape and the supply hole 425 is provided to the relatively lower portion.

Preferably, the topside 421 is configured to have a predetermined angle of inclination. If so, water poured on the topside 421 by the user automatically flows into the supply hole 425. Hence, water can be more conveniently supply to the lower housing 310.

More preferably, the predetermined angle of inclination of the topside 421 becomes lowered toward a center of the topside 421 from a circumference of the topside and the supply hole 425 is provided to the lowest portion of the topside 421, i.e., to the center of the topside 421. If so, the water poured on the topside 421 is further facilitated to be introduced into the supply hole 425.

Preferably, a filter 302 (not shown in FIG. 13, is provided to the supply hole 425 to prevent particles from being introduced into the supply hole 425.

Meanwhile, a user is able to easily recognize a level of water introduced into the lower housing 310 via the supply hole 425 as the lower housing 310 becomes filled with the water. When the lower housing 310 is being filled with water, the supply hole 425 provided to the lowest portion of the topside 421 firstly comes into contact with the rising water and the water then keeps rising over the supply hole 425.

Preferably, the supply hole 425 is provided to a position corresponding to an appropriate water level of the lower housing 420, from which the rising water starts to overflow via the supply hole 325. If the rising water overflows via the supply hole 425, a user recognizes that the water has reached the appropriate water level of the lower housing 310 and then stops supplying the water conveniently.

Preferably, a cover 422 is provided to the supply hole 425 to prevent particles from being introduced into the supply hole 425.

Preferably, a topside of the cover 422 is arranged higher than the topside of the upper housing 429 to configure a predetermined space 424 between the cover 422 and the topside 421 of the upper housing 420. If so, the water poured on the topside 421 can be introduced into the supply hole 425 via the space 424.

More preferably, the cover 422 is detachably assembled to the supply hole 425. If so, the cover 422 becomes detachable for user's convenience.

The cover 422 becomes detachable by a plurality of supports 423 fitted into the supply hole 425.

Preferably, one side of each of the supports 423 is fixed to a bottom side of the cover 422 and the other side has a holding sill to be forcibly fitted into the supply hole 425. If so, the cover 422 is forced to be fitted into the supply hole 425 by the supports 423 and then easily detached.

Preferably, each of the supports 423 has a prescribe length to configure the predetermined space 424 between the cover 422 and the topside 421.

More preferably, the supports 423 are formed in one body of the cover 422.

Preferably, the cartridge 400 further includes a predetermined filter 424 provided to the space 424, and more particularly, between the topside of the cover 42 and the topside 421 of the upper housing 420. If so, particles are prevented from being introduced into the space 424. And, a user is facilitated to recognize how many particles are attached to the filter 424, thereby deciding a time to replace or clean the filter 424.

More preferably, the filter 424 is detachably provided. In case of attempting to replace or clean the filter 424, a user is facilitated to separate the filter 424 only.

Accordingly, the present invention provides the following effects of advantages.

First of all, the present invention effectively prevents or removes wrinkles or creases from a dried object.

Secondly, the present invention sanitizes and/or deodorizes object to be dried.

Thirdly, the present invention effectively removes wrinkles or creases from clothes in a dried status without separate pressing or ironing.

Fourthly, the present invention prevents particles from being introduced into a cartridge and facilitates water to be supplied to the cartridge.

Fifthly, the present invention facilitates a cartridge to be cleaned.

Sixthly, the present invention facilitates a filter provided to a cartridge to be replaced.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A steam dryer comprising:
a drum to be selectively rotatable;
a hot-air heater to heat air to supply hot air to the drum;
a steam generator to supply steam to the drum; and
a water container to store water to be supplied to the steam generator, the water container having a supply hole on a upper portion.

2. The steam dryer of claim 1, the water container comprising:
a lower housing to store the water; and
an upper housing detachably assembled to the lower housing,
wherein the supply hole is provided to one side of the upper housing.

3. The steam dryer of claim 2, wherein the water container is detachable.

4. The steam dryer of claim 2, wherein the lower housing has an entirely open side and the upper housing is configured to cover the open side of the lower housing.

5. The steam dryer of claim 2, further comprising a sealing member provided between the upper housing and the lower housing to prevent a leakage of the water stored in the lower housing.

6. The steam dryer of claim 5, wherein the sealing member is provided to at least one of the upper housing and the lower housing.

7. The steam dryer of claim 5, wherein a groove is provided to an edge of the upper housing to be downwardly open and wherein the sealing member is inserted in the groove to be built in one body of the upper housing.

8. The steam dryer of claim 2, the water container further comprising:
an extension portion extending from one side of the upper housing to have a hole; and
a holding portion projected from one side of the lower housing to correspond to the hole.

9. The steam dryer of claim 8, wherein a holding sill is provided to a tip of the holding portion and wherein the upper housing is assembled to the lower housing in a manner that the holding sill is forcibly fitted into the hole.

10. The steam dryer of claim 2, further comprising a cover to open and close the supply hole.

11. The steam dryer of claim 10, wherein the cover is hinged to the upper housing.

12. The steam dryer of claim 11, further comprising an elastic member generating a prescribed elastic force in a direction of opening the cover.

13. The steam dryer of claim 11, wherein the cover and the upper housing are so configured that the cover is maintained at a predetermined angle when opened.

14. The steam dryer of claim 10, wherein an extension portion projected from a backside of the cover to enable the cover to be forcibly fitted into the supply hole.

15. The steam dryer of claim 14, wherein at least one holding sill outwardly projected from the extension portion is further provided to the cover.

16. The steam dryer of claim 10, wherein a seating recess is provided to a topside of the upper housing to enable the cover to be seated thereon and wherein a fingering recess is provided to one side of the seating recess.

17. The steam dryer of claim 16, wherein an opening recess is provided to a portion of the cover in the vicinity of the fingering recess when the cover is seated on the seating recess.

18. The steam dryer of claim 1, wherein the supply hole is arranged relatively lower than a top-side of the water container.

19. The steam dryer of claim 18, wherein the topside of the water container has a predetermined angle of inclination.

20. The steam dryer of claim 19, wherein the predetermined angle of the inclination of the topside of the water container is gradually reduced toward a center of the topside from a circumference of the topside.

21. The steam dryer of claim 18, wherein a cover is provided to the supply hole and wherein a topside of the cover is arranged higher than the topside of the water container.

22. The steam dryer of claim 21, wherein the cover is detachably provided.

23. The steam dryer of claim 21, wherein a filter is provided between the topside of the cover and the topside of the water container.

24. The steam dryer of claim 23, wherein the filter is detachably provided.

25. The steam dryer of claim 18, wherein a filter is provided to the supply hole.
